(19) United States
(12) Patent Application Publication
(10) Pub. No.: US 2016/0003078 A1
(43) Pub. Date: Jan. 7, 2016

(54) GASKET WITH THERMAL AND WEAR PROTECTIVE FABRIC

(71) Applicant: United Technologies Corporation, Farmington, CT (US)

(72) Inventors: Michael S. Stevens, Alfred, ME (US); Timothy M. Davis, Kennebunk, ME (US)

(21) Appl. No.: 14/742,788

(22) Filed: Jun. 18, 2015

Related U.S. Application Data
(60) Provisional application No. 62/020,151, filed on Jul. 2, 2014.

(51) Int. Cl. F01D 11/00; F01D 11/08

(52) U.S. Cl. CPC F01D 11/005; F01D 11/08; F05D 2240/55; F05D 2220/32

(57) ABSTRACT

The present disclosure relates generally to a gasket assembly for use in a gas turbine engine, the gasket assembly including a gasket component including an outer surface and end portions, and a seal component operably coupled to the outer surface of the gasket component for providing sealing contact.

### CROSS REFERENCE TO RELATED APPLICATIONS

The present application is related to, and claims the priority benefit of, U.S. Provisional Patent Application Ser. No. 62/020,151 filed Jul. 2, 2014, the contents of which are hereby incorporated in their entirety into the present disclosure

### TECHNICAL FIELD OF THE DISCLOSED EMBODIMENTS

The present disclosure is generally related to gas turbine engines and, more specifically, a gasket with thermal and wear protective fabric.

### BACKGROUND OF THE DISCLOSED EMBODIMENTS

Gas turbine engines, such as those used to power modern commercial aircraft or in industrial applications, include a compressor for pressurizing a supply of air, a combustor for burning a hydrocarbon fuel in the presence of the pressurized air, and a turbine for extracting energy from the resultant combustion gases. Generally, the compressor, combustor and turbine are disposed about a central engine axis with the compressor disposed axially upstream of the combustor and the turbine disposed axially downstream of the combustor.

In operation of a gas turbine engine, fuel is combusted in the combustor in compressed air from the compressor thereby generating high-temperature combustion exhaust gases, which pass through the turbine. In the turbine, energy is extracted from the combustion exhaust gases to turn the turbine to drive the compressor and also to produce thrust. The turbine includes a plurality of turbine stages, wherein each stage includes of a stator section formed by a row of stationary vanes followed by a rotor section formed by a row of rotating blades. In each turbine stage, the upstream row of stationary vanes directs the combustion exhaust gases against the downstream row of blades. Thus, the blades of the turbine are exposed to the high temperature exhaust gases.

The turbine blades extend outwardly from a blade root attached to a turbine rotor disk to a blade tip at the distal end of the blade. A blade outer air seal extends circumferentially about each turbine rotor section in juxtaposition to the blade tips. Desirably, a tight clearance is maintained between the blade tips and the radially inwardly facing inboard surface of the blade outer air seal so as to minimize passage of the hot gases therebetween. Hot gas flowing between the blade tips and the blade outer air seal bypasses the turbine, thereby reducing turbine efficiency.

In operation of the gas turbine engine, the blade outer air seal is exposed to the hot gases flowing through the turbine. The blade outer air seal is constructed of a plurality of blade outer air seal (BOAS) segments having longitudinal expanse and circumferential expanse and laid end-to-end abutment in a circumferential band about the turbine rotor so as to circumscribe the blade tips.

Generally, gas turbine engines include multiple gaskets of varying sizes and shapes to control leakage and gas flow. In some instances, gaskets have been shown to deteriorate quickly when in direct contact with hot cavity surfaces, particularly when the cavity is formed from segmented hardware such BOAS or vanes.

Improvements in gaskets are therefore needed in the art.

### SUMMARY OF THE DISCLOSED EMBODIMENTS

In one aspect, a gasket assembly for a gas turbine engine is provided. The gasket assembly includes a gasket component including an outer surface and end portions. In one embodiment, the gasket component includes a single continuous structure and the end portions define distal ends of the continuous structure. In one embodiment, the gasket component includes a substantially W-shaped cross-sectional shape.

The gasket assembly further includes a sealing component operably coupled to the outer surface of the gasket component. In one embodiment, the sealing component is operably coupled to at least a portion of the outer surface of the gasket component. In one embodiment, the sealing component includes a non-metallic material. In one embodiment, the non-metallic material includes a ceramic fiber.

In one aspect, a gasket assembly for a gas turbine engine is provided. The gas turbine engine includes a cavity defined between a first surface and a second surface movable relative to each other, and a gasket assembly disposed within the cavity; the gasket assembly including a gasket component including an outer surface and end portions, and a seal component affixed to the outer surface of the gasket component for providing sealing contact with each of the first and second surfaces.

In one embodiment, the first and second surfaces are substantially parallel to each other and the cavity includes a third surface transverse to the first and second surfaces. In one embodiment, the cavity is annular about an axis and the first and second surfaces are disposed transverse to the axis.

In one embodiment, the gasket component comprises a single continuous structure and the end portions define distal ends of the continuous structure. In one embodiment, the gasket component comprises a substantially W-shape cross-section. In one embodiment, the seal component is affixed to at least a portion of the outer surface. In one embodiment, the seal component comprises a non-metallic material.

Other embodiments are also disclosed.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic cross-sectional view of a gas turbine engine;

FIG. 2 is a schematic view of a portion of a turbine section of a gas turbine engine;

FIG. 3 is a schematic view of an example gasket disposed within an example cavity;

FIG. 4 is a schematic diagram of an example gasket;

FIG. 5 is a schematic diagram of an alternative embodiment of a gasket; and

FIG. 6 is a schematic diagram of an alternative embodiment of a gasket.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

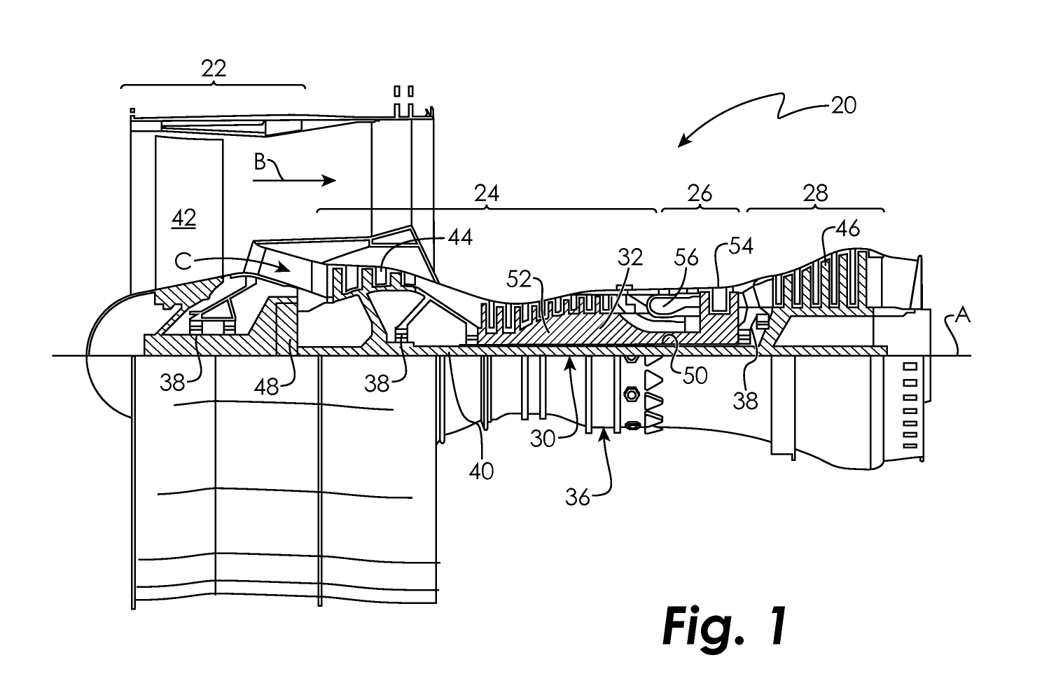

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft. (10,688 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7 ° R)]^{0.5}. The “Low corrected fan tip speed” as disclosed herein according to one non-limiting embodiment is less than about 1150 ft/second (350.5 m/sec).

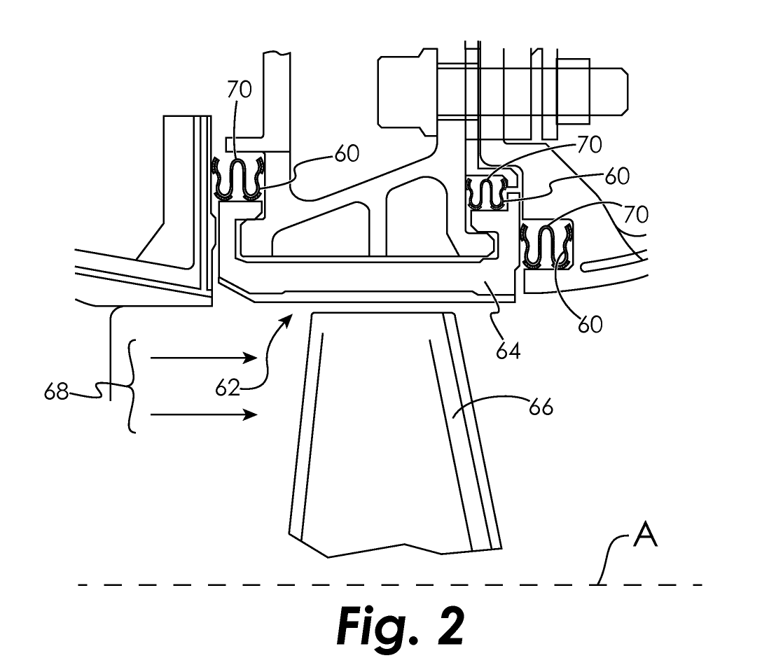

Referring to FIG. 2, an enlarged schematic view of a portion of the turbine section 28 is shown along with gaskets 60. It should be understood, that although the turbine section 28 is shown by way of example, gasket assemblies 60 are located throughout the gas turbine engine 20. The example gasket assemblies 60 are shown within a shroud assembly 62 that includes a blade outer air seal (BOAS) 64 proximate to an example turbine blade 66. Working gases, indicated at 68, produced in the combustor section 26 expand in the turbine section 28 and produce pressure gradients, temperature gradients and vibrations. The BOAS 64 are supported to provide for relative movement to accommodate expansion caused by changes in pressure, temperature and vibrations encountered during operation of the gas turbine engine 20. The gasket assemblies 60 are disposed within cavities 70 to control air flow that is outboard of the BOAS 64 from entering the flow path of the working gases 68.

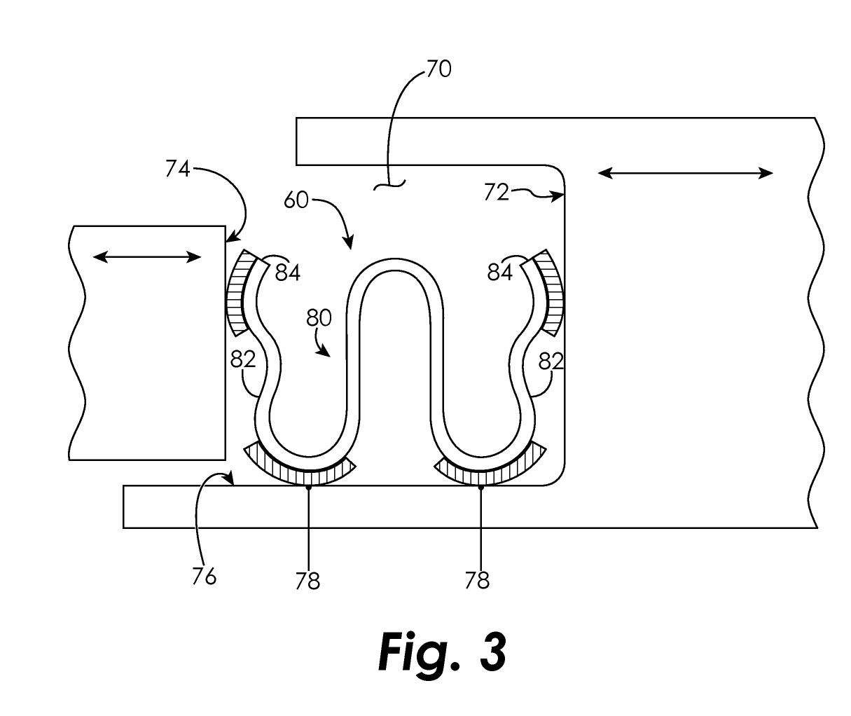

Referring to FIG. 3, one of the example cavities 70 is shown and includes a cavity first surface 72 that is movable relative to a cavity second surface 74. The surfaces 72 and 74 are portions of relative moveable parts of the shroud assembly 62 (FIG. 2). In this example, the first and second surfaces 72 and 74 are movable axially relative to each other. The cavity 70 further includes cavity bottom surface 76 that supports the gasket assembly 60. Relative movement of the first and second surfaces 72 and 74 produces a frictional interface between the gasket assembly 60 and the cavity bottom surface 76 at the points indicated at 78. Relative movement of the first and second surfaces 72 and 74 as well as the bottom surface 76 is accommodated by the gasket 60. As hot working gas enters the cavity 70, and combined with thermal condition from surrounding/contacting parts, the temperature of the first and second surfaces 72 and 74, and the bottom cavity surface 76 may increase to temperatures in excess of approximately 1500° Fahrenheit (approximately 816° Celsius).

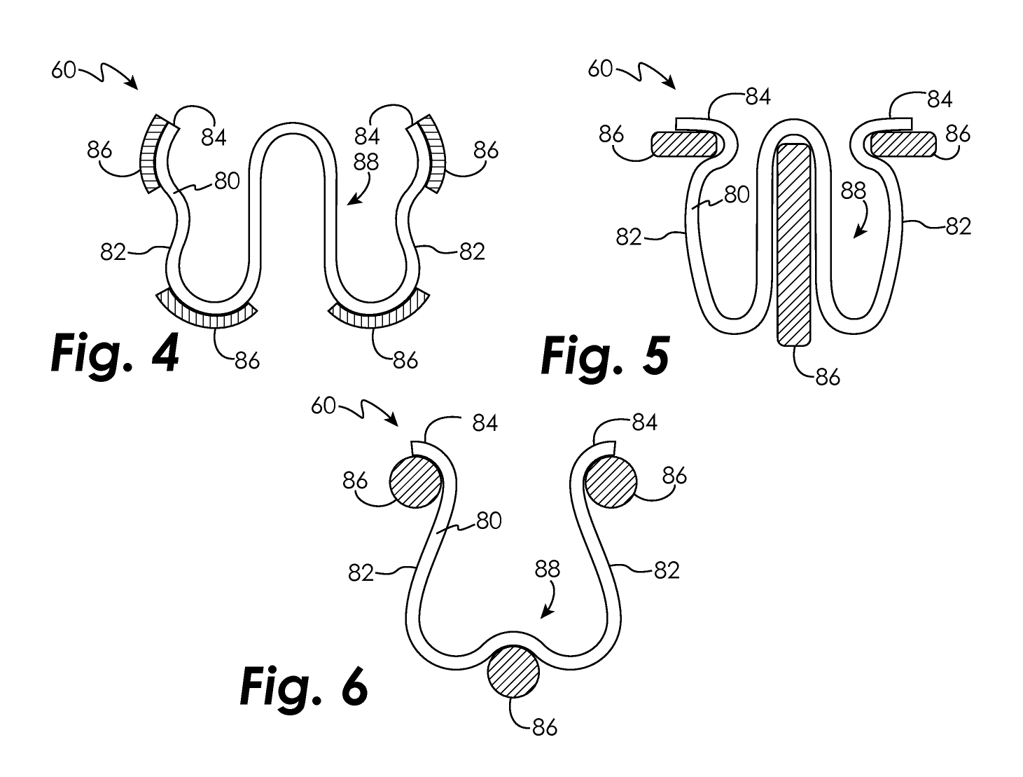

Referring to FIGS. 4-6 with continued reference to FIG. 3, the example gasket assembly 60 includes a gasket component 80 including an outer surface 82 and end portions 84. In one embodiment, the gasket component 60 includes a single continuous structure and the end portions 84 define distal ends of the continuous structure that generally defines a W-shaped cross-sectional shape.

The gasket assembly 60 further includes a sealing component 86 operably coupled to the outer surface 82 that seals against corresponding first and second surfaces 72, 74 and the cavity bottom surface 76. In one embodiment, the sealing component 86 is operably coupled to at least a portion of the outer surface 82. For example, in the embodiment shown in FIG. 4, the sealing component 86 is bonded to the outer surface 82. In the embodiment shown in FIG. 5, the sealing component 86 is crimped by the end portions 84. In the embodiment shown in FIG. 6, the sealing component includes a non-metallic rope that may be bonded or crimped by the end portions 84.

The gasket component 80 is configured to provide the desired biasing force that pushes and maintains contact pressure of the sealing component 86 against the corresponding first and second surfaces 72, 74 and the cavity bottom surface 76. In one embodiment, the sealing component 86 includes a non-metallic material, for example plastics, elastomers, polymers, textiles, and ceramic fiber materials to name a few non-limiting examples.

It will be appreciated that the gasket assembly 60 includes a sealing component 86 to act as a thermal barrier for the gasket component 80 to prevent over-heating and reduce the wear on the gasket component 80.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A gasket assembly for a gas turbine engine, the gasket assembly comprising:
a gasket component including an outer surface and end portions; and
a seal component operably coupled to the outer surface of the gasket component for providing sealing contact.

2. The gasket assembly of claim 1, wherein the gasket component comprises a single continuous structure and the end portions define distal ends of the continuous structure.

3. The gasket assembly of claim 1, wherein the gasket component comprises a substantially W-shape cross-section.

4. The gasket assembly of claim 1, wherein the seal component is operably coupled to at least a portion of the outer surface.

5. The gasket assembly of claim 1, wherein, the seal component comprises a non-metallic material.

6. The gasket assembly of claim 1, wherein the non-metallic material comprises a ceramic fiber:

7. A gas turbine engine comprising:
a cavity defined between a first surface and a second surface movable relative to each other; and
a gasket assembly disposed within the cavity, the gasket assembly including a gasket component including an outer surface and end portions, and a seal component affixed to the outer surface of the gasket component for providing sealing contact with each of the first and second surfaces.

8. The gas turbine engine of claim 7, wherein the first and second surfaces are substantially parallel to each other and the cavity includes a third surface transverse to the first and second surfaces.

9. The gas turbine engine of claim 8, wherein the cavity is annular about an axis and the first and second surfaces are disposed transverse to the axis.

10. The gas turbine engine of claim 7, wherein the gasket component comprises a single continuous structure and the end portions define distal ends of the continuous structure.

11. The gas turbine engine of claim 7, wherein the gasket component comprises a substantially W-shape cross-section.

12. The gas turbine engine of claim 7, wherein the seal component is affixed to at least a portion of the outer surface.

13. The gas turbine engine of claim 7, wherein the seal component comprises a non-metallic material.

14. The gas turbine engine of claim 13, wherein the non-metallic material comprises a ceramic fiber.
